(19) United States
(12) Patent Application Publication
(10) Pub. No.: US 2015/0300049 A1
(43) Pub. Date: Oct. 22, 2015

(54) LUGGAGE LOCKING MECHANISM

(71) Applicant: eBags Inc., Greenwood Village, CO (US)

(72) Inventor: Bernard H. Majeau, Highlands Ranch, CO (US)

(73) Assignee: EBAGS, INC., Greenwood Village, CO (US)

(21) Appl. No.: 14/682,929

(22) Filed: Apr. 9, 2015

Related U.S. Application Data
(60) Provisional application No. 61/981,646, filed on Apr. 18, 2014.

(51) Int. Cl. E05B 65/52; E05B 37/00

(52) U.S. Cl. CPC E05B 65/52; E05B 37/0034

(57) ABSTRACT

A luggage locking mechanism is provided for securably locking luggage. The luggage locking mechanism comprises tamper-proof features including overlapping or crossing pull tabs, pull tabs with locking members positioned at an angle relative to the longitudinal axis of the pull tabs, and a locking apparatus having openings for the locking members. Either the locking members may be positioned at an angle relative to the longitudinal axes of the pull tabs, the openings may be positioned at an angle relative to an axis orthogonal to the zipper track, or both may be positioned at angles relative to the longitudinal axes. The tamper-proof features prevent an unauthorized person from opening luggage an appreciable distance because the portion of the zipper track between the sliders cannot be accessed.

### RELATED APPLICATIONS

This application claims priority under 35 U.S.C. §119 to U.S. Provisional Application No. 61/981646 filed on Apr. 18, 2014 and titled “Luggage Locking Mechanism.”

### INTRODUCTION

Luggage security is an essential concern for many travelers. For this reason, luggage and travel bags are typically provided with means for securing one or more access points. Zippers are a common access point to luggage content. A zipper comprises a zipper track having two opposing teeth tracks, one or more sliders that are engaged to the zipper track, and pull tabs that are engaged to the one or more sliders. When the pull tabs are pushed or pulled along the zipper track, the one or more sliders move in the direction of the push or pull and latch the opposing teeth tracks together using a channel that meshes or separates the opposing teeth tracks depending of the direction of the sliders along the zipper track. In travel bags that have zippers, one prominent solution is to provide a locking apparatus that may be affixed to the distal ends of one or more pull tabs that are engaged to sliders that have been pulled together to prevent access to secured compartments. In this solution, unauthorized persons may tamper with such luggage locking systems and gain access to the luggage contents by exploiting the small gap that may be achieved by separating the sliders. Moreover, such luggage locking mechanisms may be severed by a cutting mechanism that can fit between the lock and the zipper.

It is with respect to these and other general considerations that the aspects disclosed herein have been made. Also, although relatively specific problems may be discussed, it should be understood that the examples should not be limited to solving the specific problems identified above or elsewhere in this disclosure.

### Luggage Locking Mechanism

The present disclosure describes a luggage locking mechanism with tamper-proof features. The novel tamper-proof features include a first pull tab comprising a first locking member, a second pull tab comprising a second locking member, a locking apparatus comprising a housing defining a first and second opening, and an actuable bolt configured to engage locking members on the first and second pull tabs. In some exemplary aspects, the locking members may be positioned in the locking apparatus housing such that the pull tabs are arranged substantially diagonally to the engaged zipper track (e.g., in an “X” shape) when the locking mechanism is engaged. Such a crossed pull tab configuration reduces the space between the pull tabs and the luggage such that it is difficult to sever or tamper with the first pull tab and the second pull tab. The tamper-proof features provided herein increase luggage security by preventing an unauthorized person from opening luggage an appreciable distance.

These and other features and advantages, which character the present non-limiting aspects, will be apparent from a reading of the following detailed description and a review of the associated drawings. It is to be understood that both the foregoing general description and the following detailed description are explanatory only and are not restrictive of the non-limiting aspects as claimed.

### BRIEF DESCRIPTION OF THE DRAWINGS

Non-limiting and non-exhaustive aspects of the luggage locking mechanism are described with reference to the following Figures in which:

FIG. 1 illustrates a prior art embodiment of a luggage locking mechanism in a locked position;

FIG. 2 illustrates a prior art embodiment of a luggage locking mechanism in an engaged position;

FIG. 3 illustrates an embodiment of a luggage locking mechanism in a crossed pull tab configuration;

FIG. 4A illustrates an embodiment of a luggage locking mechanism in a disengaged position;

FIG. 4B illustrates multiple locking member configurations for a luggage locking mechanism.

FIG. 5 illustrates a piece of luggage including an embodiment of a luggage locking mechanism using the crossed pull tab configuration.

FIGS. 6A and 6B illustrate a side and front elevation view of the luggage locking mechanism in a crossed pull tab configuration;

FIGS. 7A and 7B illustrate a side and front elevation view of the luggage locking mechanism in a crossed pull tab configuration, with an alternate embodiment of the pull tab locking members.

It should be understood that the drawings are not necessarily to scale, and various dimensions may be altered. In certain instances, details that are not necessary for an understanding of the present embodiments or that render other details difficult to perceive may have been omitted.

### DETAILED DESCRIPTION

Various aspects of the locking mechanism are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. For the purposes of explanation, the tamper-proof locking mechanism will be described in the context of a luggage locking mechanism. However, one skilled in the art will recognize that this locking mechanism may be equally adapted for any situation where two sliders are used.

The present disclosure describes a luggage locking mechanism with tamper-proof features. The novel tamper-proof features include a first slider engaged to a first pull tab comprising a first locking member, a second slider engaged to a second pull tab comprising a second locking member, a locking apparatus comprising a housing defining a first and second opening, and an actuable bolt configured to engage locking members on the first and second pull tabs. In some exemplary aspects, the locking members may be positioned in the locking apparatus housing such that the pull tabs are arranged substantially diagonally to the engaged zipper track when the locking mechanism is engaged. The tamper-proof features provided herein increase luggage security by preventing an unauthorized person from separating the sliders an appreciable distance without disengaging the pull tabs, thus allowing access to the luggage in order to remove or tamper with luggage contents.

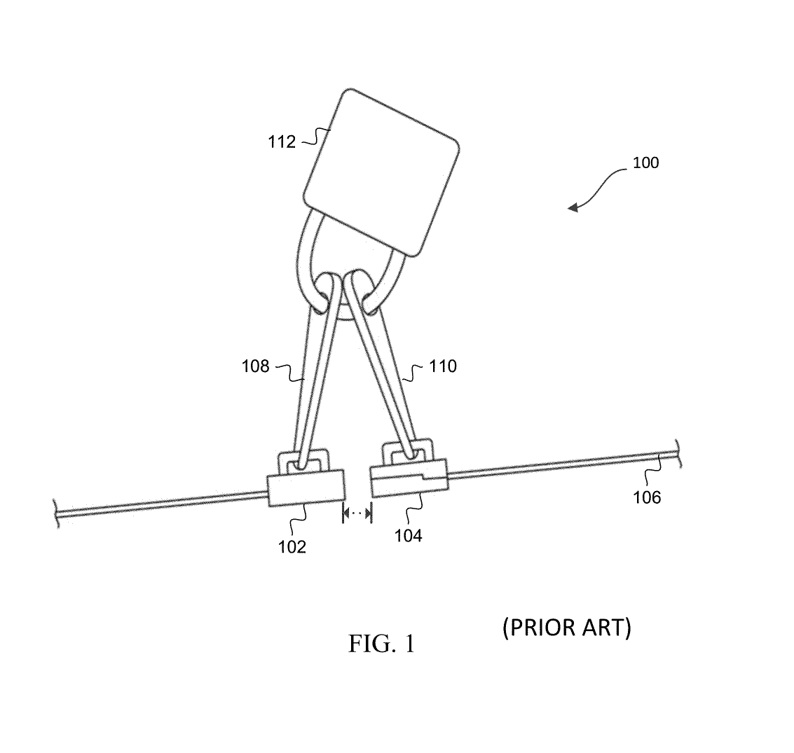

FIG. 1 illustrates a prior art luggage locking mechanism 100 in a locked position. The locking mechanism 100 includes a first slider 102 and a second slider 104 that have been brought substantially together on a zipper track 106. First slider 102 includes a pull tab 108 comprising an aperture at the distal end of the pull tab 108. Second slider 102 similarly includes a pull tab 110 comprising an aperture at the distal end of the pull tab 110. A locking mechanism 112 is threaded between the apertures of pull tabs 108, 110 and engaged to prevent an unauthorized person from accessing the contents of the luggage. However, as shown in FIG. 1, the geometry of the locking mechanism 100 is such that the sliders 102, 104 may be separated a small distance (e.g., approximately twice the length of the pull tabs, which in practice can be one inch or more) before the locking mechanism 100 restricts further separation of the sliders 102, 104. This small opening may be sufficient for an unauthorized person to extract or otherwise tamper with the contents of the luggage, for example, by using a hook or some other tool to extract items from the luggage.

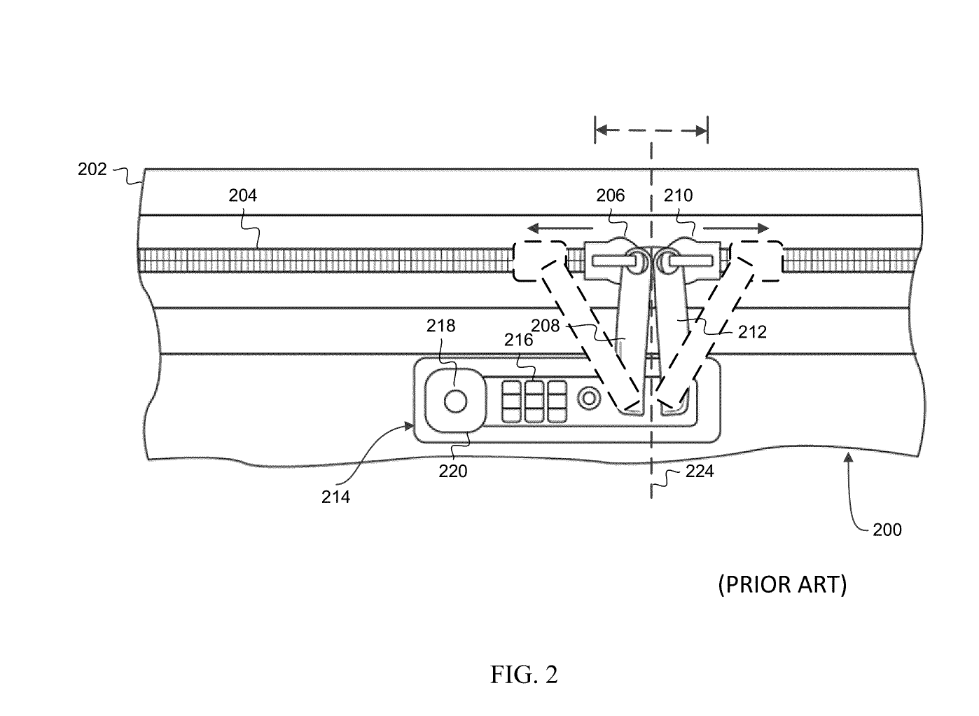

FIG. 2 illustrates a prior art embodiment of a luggage locking mechanism 200 in an engaged position. The luggage locking mechanism 200 includes a zipper track 204 disposed around the luggage 202, a first slider 206 engaged with the zipper track 204 and comprising a first pull tab 208, a second slider 210 engaged with the zipper track 204 and comprising a second pull tab 212, and a locking apparatus 214. The locking apparatus 214 includes a combination lock 216, a key lock 218, a release member 220 and a housing defining a first opening (not visible in FIG. 2) and a second opening (not visible in FIG. 2). The first pull tab 208 includes a first locking member (not visible in FIG. 2) and the second pull tab 212 includes a second locking member (not visible in FIG. 2). A reference axis 224 that is disposed between the first opening and the second opening. As illustrated, the first locking member is received in the locking apparatus first opening such that first locking member and the locking apparatus first opening are disposed on a first side of the reference axis 224. Similarly, the second locking member is received in the locking apparatus second opening such that second locking member and the locking apparatus second opening are disposed on a second side of the reference axis 224. In such an embodiment, the geometry of the locking mechanism 200 is such that the sliders 206, 210 may be separated a small distance before the locking mechanism restricts further separation of the sliders 206, 210. As in FIG. 1, the small opening that results from separating the sliders 206, 210 may be sufficient for an unauthorized person to extract or otherwise tamper with the contents of the luggage.

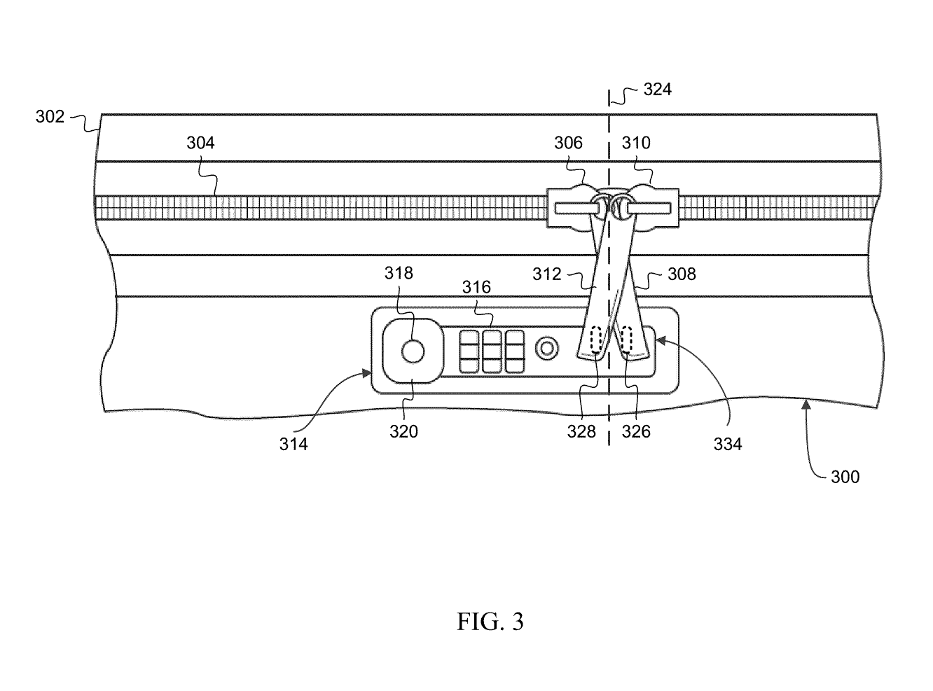

FIG. 3 illustrates an embodiment of the luggage locking mechanism 300 in a crossed pull tab configuration. The embodiment in FIG. 3 represents one viewing perspective of a luggage item in which the zipper track is engaged and the two sliders are brought together. The luggage locking mechanism 300 may be disposed on luggage 302, camping equipment, sporting goods, or on similar containers. The luggage locking mechanism 300 includes a zipper track 304 disposed around the luggage 302, a first slider 306 movably engaged with the zipper track 304, a first pull tab 308 engaged with the first slider 306, a second slider 310 movably engaged with the zipper track 304, a second pull tab 312 engaged with the second slider 306 and a locking apparatus 314. The locking apparatus 314 includes a combination lock 316, a key lock 318, an actuable bolt (not visible in FIG. 3), a release member 320 and a housing 334 defining a first opening (not visible in FIG. 3) beneath first pull tab 308 and a second opening (not visible in FIG. 3) beneath second pull tab 312.

In embodiments, a zipper track includes two opposing teeth tracks. The teeth tracks may be disposed on opposite halves of the luggage 302. In some embodiments, the teeth tracks are interlocked when the sliders are brought together, thereby engaging the zipper track. As in FIG. 3, the engaged zipper track 304 may be substantially orthogonal to a reference axis 324 that is disposed between the first opening and the second opening.

The sliders 306, 310 are used to latch the portions of the zipper track together using a channel that meshes or separates the opposing portions of the teeth strip depending of the direction of the sliders along the zipper track. The sliders 306, 310 may be different shapes and sizes to accommodate the shape and size of the zipper track.

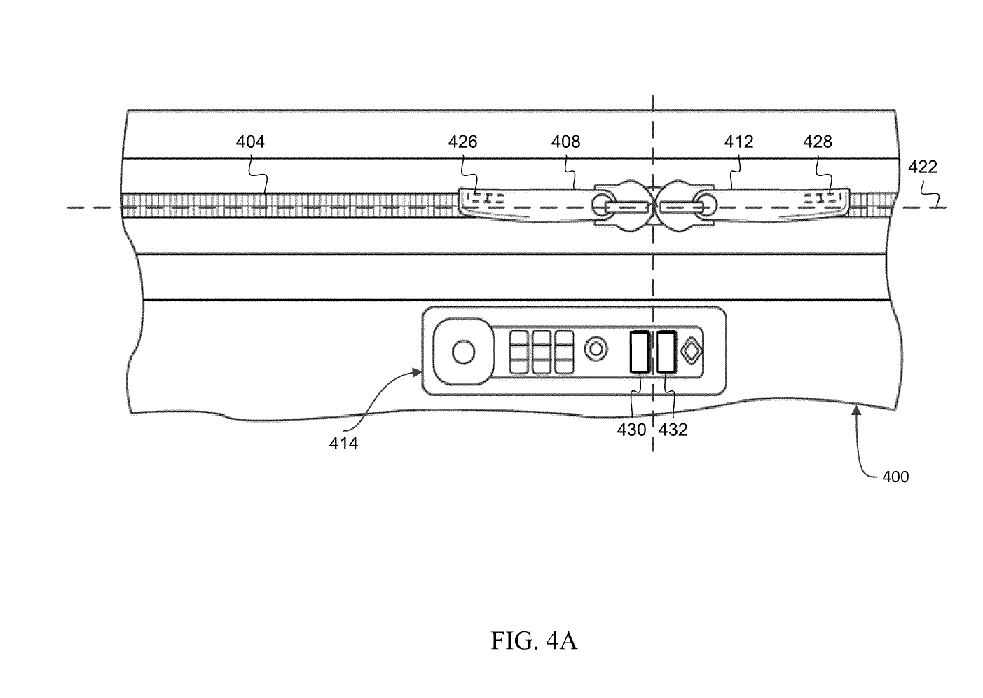

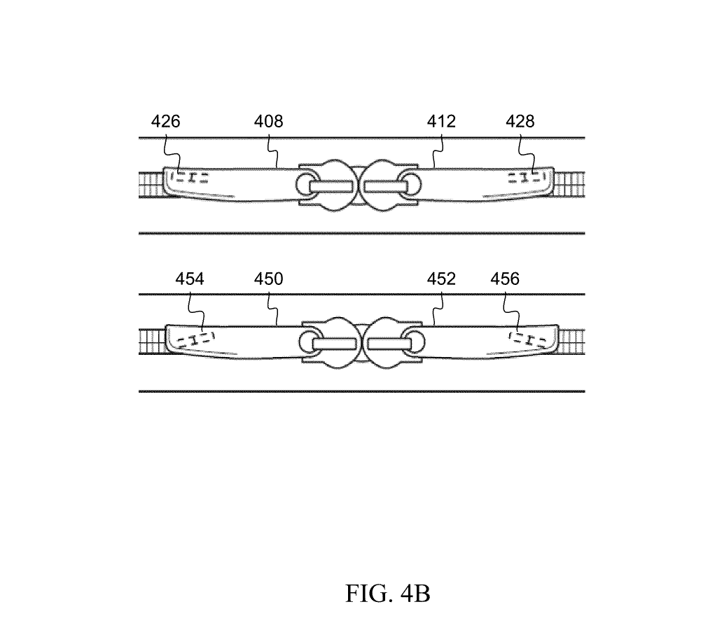

The pull tabs 308, 312 are used to facilitate moving the sliders along the zipper track. The pull tabs may be several different shapes and/or configurations. In embodiments, a pull tab may be primarily in the shape of an oval, a circle, a square, a rectangle, a triangle, etc. For example, pull tabs 308, 312 have a rectangular shape such that the longest dimension of the pull tab defines a longitudinal axis, as illustrated in FIG. 4. The rectangular shape may define a plurality of sections along the longitudinal axis of the pull tabs. For example, the pull tab may include a proximal section that is proximate to the slider, a middle section and a distal section that is distal to the slider along the longitudinal axis. The proximal section of the pull tab may be engaged to the slider and the distal section may be opposite the proximal section along the longitudinal axis. In aspects, a surface of the pull tab may be flat, textured and/or or may include an elastic loop attached to a base portion that is engaged to the slider. In FIG. 3, the first pull tab 308 includes a first locking member 326. The first locking member 326 is disposed beneath the engaged first pull tab 308 and is received in the locking apparatus second opening (not visible) such that first locking member 326 and the locking apparatus second opening are disposed on different sides of the reference axis 324. The second locking member 328 is disposed beneath the engaged second pull tab 312 and is received in the locking apparatus first opening (likewise, not visible) such that second locking member 328 and the locking apparatus first opening are disposed on different sides of the reference axis 324. In such aspects, the first pull tab 308 crosses over or under the second pull tab 312 when the locking member 326, 328 are received in the locking apparatus openings, thus forming an “X” shape. For example, the pull tabs 308, 312 and second pull tab 312 are positioned with one of the first pull tab 308 and the second pull tab 312 on top of, and possibly touching, the other pull tab.

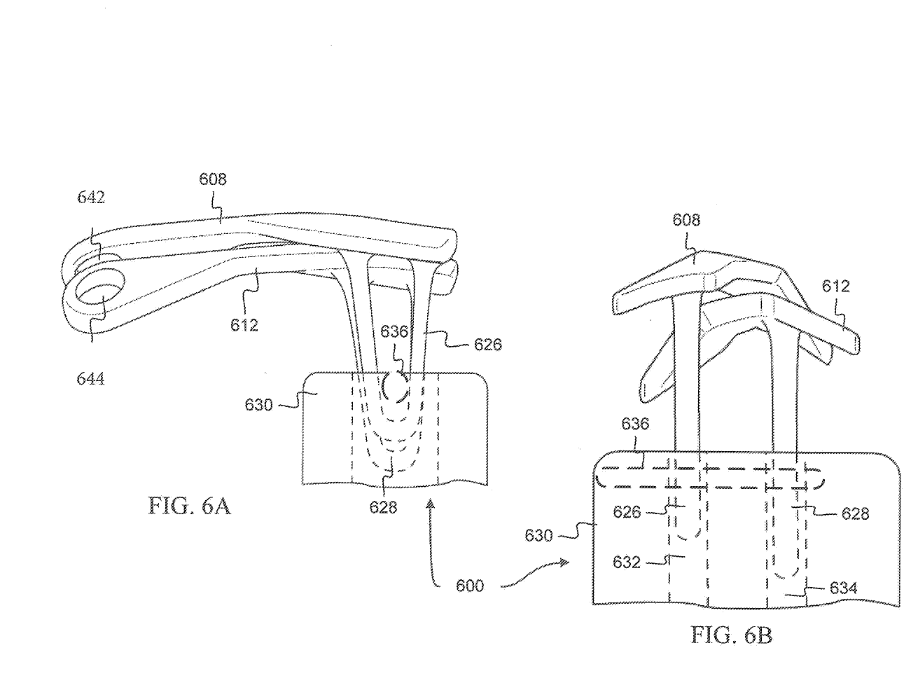

In some embodiments, at least one of pull tabs 308, 312 are curved or capable of being bent into a curve (as shown in FIGS. 6A-6B) to facilitate engagement of the locking members 326, 328 with the locking apparatus openings using the crossed pull tab configuration. In other embodiments, pull tabs 308, 312 may include sections that are curved or capable of being bent into a curve. For example, the middle section of a pull tab may be curved or flexible to facilitate crossing over or under the other pull tab. In another example, the proximal section and/or distal section of a pull tab may be curved or flexible to facilitate crossing over or under the other pull tab. The curve or flexibility of the pull tabs may be such that either pull tab may be crossed over the other pull tab. In such embodiments, the angle of the locking members 326, 328 with respect to the longitudinal axis of the pull tabs 308, 312 may be such that the locking members are received within the locking apparatus openings at an angle parallel to the reference axis. Moreover, as discussed in more detail below, the locking members 326, 328 may be different sizes and shapes and may be engaged at different depths within the locking apparatus openings, with respect to each other.

As shown is FIG. 3, the geometry of the crossed pull tab configuration of the locking mechanism 300 reduces the distance the sliders 306, 310 and pull tabs 308, 312 may be separated, in comparison to the prior art. The reduction in the opening that results from separating the sliders 306, 310 is sufficient to make it difficult, if not impossible, for an unauthorized person to extract or otherwise tamper with the contents of the luggage 302. Additionally, the crossed pull tab configuration reduces the maneuverability of the engaged pull tabs, with respect to the prior art. For example, when the pull tab locking members 326, 328 are engaged within the locking apparatus 314, there is only a small distance (e.g., approximately 0.25 inches) can be achieved between the pull tabs 308, 312 and the luggage 302. This small distance makes it difficult for an unauthorized person to sever the pull tabs 308, 312 by fitting a cutting mechanism between the pull tabs 308, 312 and the locking apparatus 314. Moreover, the crossed pull tab configuration decreases access to the engaged locking members 326, 328, with respect to the prior art. For example, when the locking members 326, 328 are engaged within the locking apparatus 314, there is essentially no opportunity for an unauthorized person to sever the locking members 326, 328 by fitting a cutting mechanism between the locking members 326, 328 and the locking apparatus 314.

FIG. 4A and illustrates an embodiment of the luggage locking mechanism 400, in a disengaged configuration. In FIG. 4A, the first pull tab 408 is free to move but illustrated as positioned substantially parallel to the engaged zipper track 404 and is disposed such that the first pull tab 408 and the locking apparatus first opening 430 are disposed on a first side of the reference axis 224. The first pull tab 408 includes a first locking member 426 that is positioned substantially parallel to the longitudinal axis 422 of the first pull tab 408. Similarly, in the disengaged configuration shown, the second pull tab 412 is positioned substantially parallel to the engaged zipper track 404 and is disposed such that the second pull tab 412 and the locking apparatus second opening 432 are disposed on a second side of the reference axis 224. The second pull tab 412 includes a second locking member 428 that is positioned substantially parallel to the longitudinal axis 422 of the second pull tab 412.

Although the first locking member 426 and the second locking member 428 are shown as positioned substantially parallel to the longitudinal axis 422 of the first pull tab 408 and second pull tab 412, respectively, alternate locking member configurations (with respect to the longitudinal axes of the pull tabs) are contemplated. For example, FIG. 4B illustrates a second configuration of the locking members of luggage locking mechanism 400. In FIG. 4B, the first pull tab 450 includes a first locking member 454 that is positioned at an angle that is substantially diagonal to the longitudinal axis 422 of first pull tab 450. Similarly, the second pull tab 452 is positioned at an angle that is substantially diagonal to the longitudinal axis of second pull tab 452. As in FIG. 4A, pull tabs 450, 452 are free to move, but illustrated as positioned substantially parallel to the engaged zipper track 404.

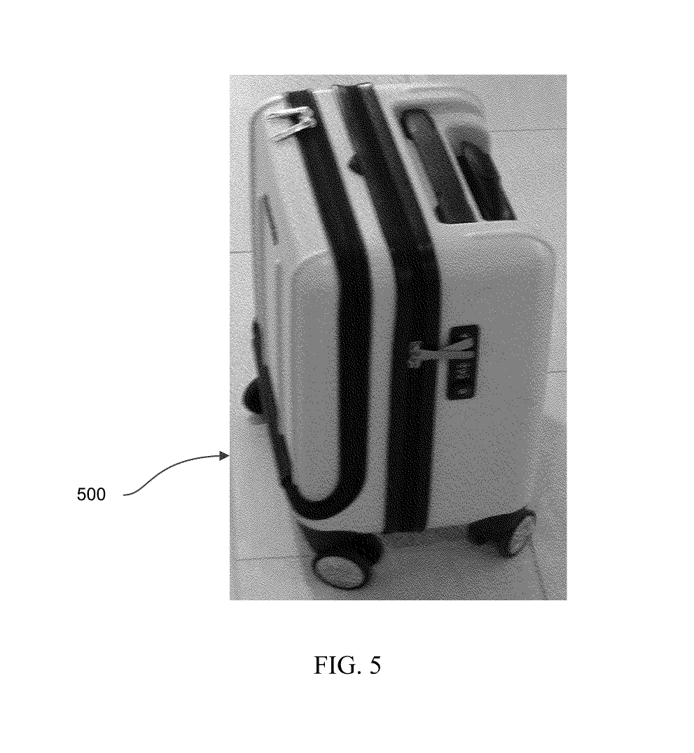

FIG. 5 illustrates a piece of luggage 500 including an embodiment of the luggage locking mechanism using the crossed pull tab configuration.

FIGS. 6A and 6B described here together illustrate side and front elevation views, respectively, of the luggage locking mechanism 600. As shown, luggage locking mechanism 600 includes a first pull tab 608, a second pull tab 612 and a housing 630 defining a locking apparatus first opening 632 and a locking apparatus second opening 634. The first pull tab 608 includes a first locking member 626 and a first pull tab aperture 632. The second pull tab 612 includes a second locking member 628 and a second pull tab aperture 634. The pull tab aperture may be used to affix the pull tab to a zipper (not shown) either directly or indirectly.

In some aspects, each of the pull tabs 608, 612 may be curved or capable of being bent into a curve to facilitate engagement of the first locking member 626 and/or second locking member 628 with the locking apparatus first openings 632, 634 using the crossed pull tab configuration described in FIG. 3. In alternate aspects, only sections along the longitudinal axis of the pull tabs may be curved or capable of being curved. For example, the pull tabs 608, 612 may be curved such that the locking members 626, 628 are received substantially parallel to the locking apparatus openings 632, 634 when pull tabs 608, 612 are in the crossed pull tab configuration, regardless of which pull tab is crossed over the other pull tab. The curve of pull tab 608, 612 may further be such that locking members 626, 628 are received substantially parallel to the locking apparatus openings 632, 634 when pull tabs 608, 612 are in the uncrossed pull tab configuration.

Furthermore, each of the locking members 626, 628 may be disposed at an angle relative to one or more axes of the pull tabs 608, 612. For example, locking members 626, 628 may be disposed substantially diagonally to the longitudinal axis of the pull tabs 608, 612. In other examples, the locking members 626, 628 may be disposed substantially orthogonally to the longitudinal axis of the pull tabs 608, 612. Additionally, the locking members 626, 628 shape may twist or rotate as the locking member extends outwardly from the pull tab. In embodiments, the locking members 626, 628 may be the same size or a different size with respect to one another, and may be configured in several different shapes (e.g., an oval, a circle, a square, a rectangle, a triangle, etc.). As in the embodiment illustrated in FIGS. 6A and 6B, the pull tabs 608, 612 may also be complementary mirror images of each other.

The locking members 626, 628 may include an aperture for engaging the locking member within the locking apparatus using, for example, an actuable bolt 636. An aperture may be used to allow engaging locking members 626, 628 within the housing 630 and may be several different sizes and/or shapes (e.g., an oval, a circle, a square, a rectangle, a triangle, etc.). The actuable bolt 636 may be configured to engage locking members received at different depths and/or angles within the locking apparatus openings 632, 634, as shown in FIGS. 6A and 6B. For example, actuable bolt 636 may slide between the locking member apertures received in the locking apparatus openings in order to engage the locking members 626, 628 within the housing 630. In some aspects, the locking members may be engaged within the locking apparatus using an alternate latching mechanism.

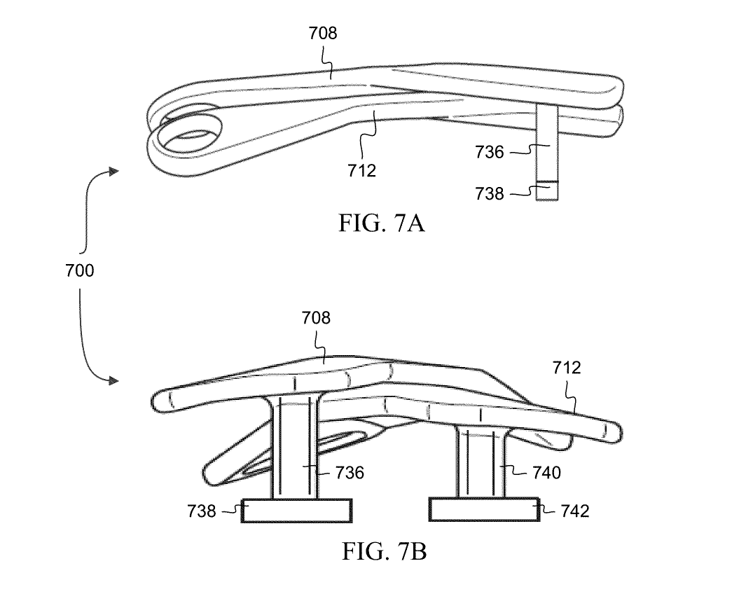

FIGS. 7A and 7B described here together illustrate side and front elevation views, respectively, of an alternate embodiment of the pull tabs locking members. The luggage locking mechanism 700 includes a first pull tab 708 and a second pull tab 712. The first pull tab 708 includes a first locking post 736 and a first locking base 738. The second pull tab 712 includes a second locking post 740 and a second locking base 742. The locking posts 736, 740 extends outwardly from the pull tabs 708, 712 and the locking bases 738, 742 are affixed to the end of the locking posts 736, 740 opposite the pull tab s 708, 712. In such aspects, the locking posts 736, 740 may be the same length or a different length with respect to one another, and the locking bases 738, 742 may be configured in different sizes and shapes (e.g., an oval, a circle, a square, a rectangle, a triangle, etc.) as long as the locking apparatus is provided with a complementary mechanism for engaging and securing the locking member.

The description and illustration of one or more examples provided herein are not intended to limit or restrict the scope of the present disclosure as claimed in any way. The examples, and details provided in this application are considered sufficient to convey possession and enable others to make and use the best mode of the claimed examples. The claimed examples should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed examples.

1. A luggage item comprising:
a zipper track disposed on the luggage item;
a first slider movably engaged with the zipper track;
a first pull tab engaged with the first slider, wherein the first pull tab includes a first locking member;
a second slider movably engaged with the zipper track;
a second pull tab engaged with the second slider, wherein the second pull tab includes a second locking member; and
a locking apparatus disposed on the luggage item, the locking apparatus including:
a housing defining a first opening and a second opening; and
an actuable bolt disposed in the housing, wherein the bolt is configured to (1) releasably engage the first locking member when the first locking member is received in the second opening, and (2) releasably engage the second locking member when the second locking member is received in the first opening;
wherein a reference axis is disposed between the first opening and the second opening;
wherein the reference axis is substantially orthogonal to the zipper track; and
wherein when the first locking member is received in the second opening, the first pull tab crosses the reference axis, and wherein when the second locking member is received in the first opening, the second pull tab crosses the reference axis.

2. The luggage item of claim 1, wherein when one of the first pull tab and second pull tab is on top of the other one of the first pull tab and second pull tab, the first locking member fits into the second opening and the second locking member fits into the first opening.

3. The luggage item of claim 2, wherein the first pull tab includes:
a proximal end, the proximal end engaged to the first slider; and
a distal end, the distal end opposite the proximal end.

4. The luggage item of claim 3, wherein the first pull tab includes a longest dimension defining a longitudinal axis of the first pull tab.

5. The luggage item of claim 1, wherein the locking apparatus further includes:
a combination lock;
a key lock; and
a release member,
wherein the key lock is integral with the release member, and wherein at least one of the combination lock and the key lock are configured to lock the actuable bolt.

6. The luggage item of claim 1, wherein at least one of the first locking member and the second locking member includes a loop.

7. The luggage item of claim 6, wherein the actuable bolt engages the first locking member when the first locking member is received in the second opening.

8. The luggage item of claim 4, wherein the first locking member is disposed on the distal end of the first pull tab, wherein the distal end of the first pull tab is rotated about the longitudinal axis of the first pull tab as compared to a proximal end of the first pull tab.

9. The luggage item of claim 8, wherein the first locking member is disposed of at an angle substantially diagonal to the distal end of the first pull tab.

10. The luggage item of claim 1, wherein at least one of the first locking member and the second locking member includes a post including an enlarged base.

11. The luggage item of claim 1, wherein the first locking member is received in the second opening at a first depth and the second locking member is received in the first opening at a second depth, wherein the first depth is different from the second depth.

12. The luggage item of claim 11, wherein the actuable bolt is configured to releasably engage the first locking member at the first depth and the second locking member at the second depth.

13. The luggage item of claim 1, wherein the first pull tab is a complimentary mirror image of the second pull tab.

14. A locking mechanism comprising:
a first pull tab, wherein the first pull tab includes a first locking member;
a second pull tab, wherein the second pull tab includes a second locking member;
a locking apparatus, wherein the locking apparatus includes:
a housing defining a first opening and a second opening; and
an actuable bolt disposed in the housing, wherein the bolt is configured to (1) releasably engage the first locking member when the first locking member is received in the second opening, and (2) releasably engage the second locking member when the second locking member is received in the first opening.

15. The locking mechanism of claim 14, wherein when the first locking member is received in the second opening, the first pull tab crosses the reference axis, and wherein when the second locking member is received in the first opening, the second pull tab crosses the reference axis.

16. The locking mechanism of claim 14, wherein the first locking member is received in the second opening at a first depth and the second locking member is received in the first opening at a second depth, wherein the first depth is different from the second depth, and wherein the actuable bolt is configured to releasably engage the first locking member at the first depth and the second locking member at the second depth.

17. The locking mechanism of claim 14, wherein the second locking member includes a post extending from a distal end of the second locking member.

18. The locking mechanism of claim 17, wherein the post includes a base, wherein the base is selected from: an oval shape, a circle shape, a square shape, a rectangle shape and a triangle shape.

19. The locking mechanism of claim 14, wherein the first pull tab includes a first pull tab axis disposed along the longitudinal axis of the first pull tab and wherein the first locking member is disposed on a distal end of the first pull tab.

20. The locking mechanism of claim 19, wherein the distal end of the first pull tab is rotated about the first pull tab axis as compared to a proximal end of the first pull tab, and wherein the first locking member is disposed of at an angle substantially diagonal to the distal end of the first pull tab.
